(19) United States
(12) Patent Application Publication
(10) Pub. No.: US 2026/0039045 A1
(43) Pub. Date: Feb. 5, 2026

(54) CONNECTOR ASSEMBLY

(71) Applicant: ADVANCED-CONNECTEK INC., New Taipei City (TW)

(72) Inventors: Shu-Fen Wang, New Taipei City (TW); Kuan-Lin Chen, New Taipei City (TW); Hou-Bin Lin, New Taipei City (TW)

(21) Appl. No.: 19/283,493

(22) Filed: Jul. 29, 2025

(30) Foreign Application Priority Data
Aug. 2, 2024 (TW) 113208355

(51) Int. Cl. H01R 12/79; H01R 12/70; H01R 12/72; H01R 12/77; H01R 13/24

(52) U.S. Cl. CPC H01R 12/79; H01R 12/7082; H01R 12/727; H01R 12/775; H01R 13/24

(57) ABSTRACT

A connector assembly includes a board-end connector and a cable-end connector. The board-end connector includes an outer shell, an insulated housing, and a terminal module. The insulated housing has a receiving cavity. Two ends of the insulated housing have an insertion opening and an assembling opening in communication with the receiving cavity, respectively. The terminal module is in the receiving cavity and includes ground terminals and pairs of signal terminals arranged as a single row along an axial line. The cable-end connector includes a flexible parallel cable and a plug at one end of the flexible parallel cable. When the plug of the cable-end connector is inserted into the receiving cavity through the insertion opening, each of contacts on the plug firstly contacts a first contact portion of a corresponding one of the ground terminals and then contacts a second contact portion of a corresponding one of the signal terminals.

### CROSS-REFERENCE TO RELATED APPLICATION

This non-provisional application claims priority under 35 U.S.C. § 119 (a) to patent application No. 113208355 filed in Taiwan, R.O.C. on Aug. 2, 2024, the entire contents of which are hereby incorporated by reference.

### FIELD OF THE INVENTION

The instant disclosure relates to a connector, and more particular to a connector assembly.

### BACKGROUND

The connection interfaces in telecommunication industry are developed to be lightweight and tiny and to have stable signal transmissions. For the connection interfaces applied in high speed transmission server and switch, for example, the mini cool edge IO (MCIO) connector, the MCIO connector has a small size plus reliable and stable connection. An MCIO connector known to the inventor includes a board-end connector and a cable-end connector. The cable-end connector comprises a cable, a PCB, and a plug on the PCB. The plug has a plastic core, upper and lower terminals, and a hook member. As a result, the components of the connector is complicated, and thus the manufacturing cost for the connector is high. Moreover, in the manufacturing process of the cable-end connector, the cable has to be welded with the PCB board, and the manufacturing process is complicated.

### SUMMARY OF THE INVENTION

In view of these, some embodiments of the instant disclosure provides a connector assembly comprising a board-end connector and a cable-end connector. The board-end connector comprises an outer shell, an insulated housing, and a terminal module. The insulated housing is in the outer shell and has a receiving cavity. One of two ends of the insulated housing has an insertion opening in communication with the receiving cavity, and the other end of the insulated housing has an assembling opening in communication with the receiving cavity. The terminal module is in the receiving cavity. The terminal module comprises a plurality of ground terminals and a plurality of pairs of signal terminals arranged as a single row along an axial line. Each of the pairs of the signal terminals are between corresponding two of the ground terminals, each of the ground terminals comprises a first contact portion adjacent to the insertion opening, and each of the signal terminals comprises a second contact portion away from the insertion opening. The cable-end connector comprises a flexible parallel cable and a plug at one end of the flexible parallel cable, and one surface of the plug comprises a plurality of contacts. When the plug of the cable-end connector is inserted into the receiving cavity through the insertion opening, each of the contacts firstly contacts the first contact portion of a corresponding one of the ground terminals and then contacts the second contact portion of a corresponding one of the signal terminals.

In some embodiments, each of the ground terminals comprises a first body portion and a first tail portion adjacent to the assembling opening, and the first contact portion and the first tail portion are at two ends of the first body portion, respectively. each of the signal terminals comprises a second body portion and a second tail portion adjacent to the assembling opening, and the second contact portion and the second tail portion are at two ends of the second body portion, respectively.

In some embodiments, each of the signal terminals defines a longitudinal axis and a transverse axis, and each of the ground terminals defines a longitudinal axis and a transverse axis. For each of the signal terminals, the transverse axis is perpendicular to the longitudinal axis. For each of the ground terminals, the transverse axis is perpendicular to the longitudinal axis. A first width of each of the signal terminals along the transverse axis of the signal terminal is greater than a second width of a corresponding one of the ground terminals along the transverse axis of the ground terminal.

In some embodiments, a connection line between the first contact portions defines a first axial line, and the first contact portions are arranged along the first axial line and spaced apart from each other. A connection line between the second contact portions defines a second axial line, and the second contact portions are arranged along the second axial line and spaced apart from each other. The axial line, the first axial line, and the second axial lien are parallel with each other.

In some embodiments, each of the signal terminals and the ground terminals is a flexible terminal, and each of the first contact portion and the second contact portion is a curved structure and at an insertion path between the insertion opening and the receiving cavity.

In some embodiments, the terminal module comprises a terminal base formed with the first body portions of the ground terminals and the second body portions of the signal terminals, and the first tail portions of the ground terminals and the second tail portions of the signal terminals are exposed from the terminal base.

In some embodiments, each of two sides of the terminal base comprises a plurality of protrusions and an engaging block, and the insulated housing comprises a recessed portion and an engaging groove at each of two sides of an inner wall of the assembling opening. Each of the protrusions correspondingly contacts an inner wall of a corresponding one of the recessed portions, and each of the engaging blocks is correspondingly engaged with a corresponding one of the engaging grooves.

In some embodiments, the connector assembly further comprises a conductive body. The conductive body comprises a main body and a plurality of extension portions, the main body is in the receiving cavity and on the terminal base, and the extension portions outwards extend from the main body and respectively connected to the first body portions.

In some embodiments, the number of the signal terminals and the ground terminals is 37, the number of the signal terminals is 24, and the number of the ground terminals is 13.

In some embodiments, the flexible parallel cable is a flexible flat cable, each of the contacts is a flat terminal, a connection line between the contacts is defined as a third axial line, the contacts are arranged along the third axial line and spaced apart from each other, and the contacts at the one surface of the plug are arranged into a single row.

According to some embodiments of the instant disclosure, through the configuration that the first contact portions of the ground terminals are adjacent to the insertion opening of the insulated housing and the second contact portions of the signal terminals are away from the insertion opening, when the plug of the cable-end connector is inserted into the receiving cavity through the insertion opening of the insulated housing, some of the contacts on the plug of the cable-end connector firstly contact the first contact portions of the ground terminals, and then when the plug is further inserted into the receiving cavity, rest of the contacts contact the second contact portions of the signal terminals. Therefore, the terminal contact of the ground terminals is achieved firstly for grounding and noise conduction and then the terminal contact of the signal terminals is achieved for signal transmission.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of a connector assembly according to some embodiments of the instant disclosure, where a board-end connector and a cable-end connector of the connector assembly are not mated with each other yet;

FIG. 2 illustrates a front exploded view of the board-end connector according to some embodiments of the instant disclosure;

FIG. 3 illustrates a rear exploded view of the board-end connector according to some embodiments of the instant disclosure;

FIG. 4 illustrates a partial exploded view of the terminal module according to some embodiments of the instant disclosure;

FIG. 5 illustrates a front view of the board-end connector according to some embodiments of the instant disclosure;

FIG. 6 illustrates a cross-sectional view along line 6-6 shown in FIG. 5, where the board-end connector and the cable-end connector of the connector assembly are not mated with each other yet;

FIG. 7 illustrates a cross-sectional view along line 6-6 shown in FIG. 5, where the board-end connector and the cable-end connector of the connector assembly are mated with each other; and

FIG. 8 illustrates a cross-sectional view along line 7-7 shown in FIG. 5, showing the top cross-sectional view of the connector assembly.

### DETAILED DESCRIPTION

To illustrate the embodiments of the instant disclosure, in the drawings, the first axis X is the X axis of the Cartesian coordinate, the second axis Y is the Y axis of the Cartesian coordinate, and the third axis is the Z axis of the Cartesian coordinate.

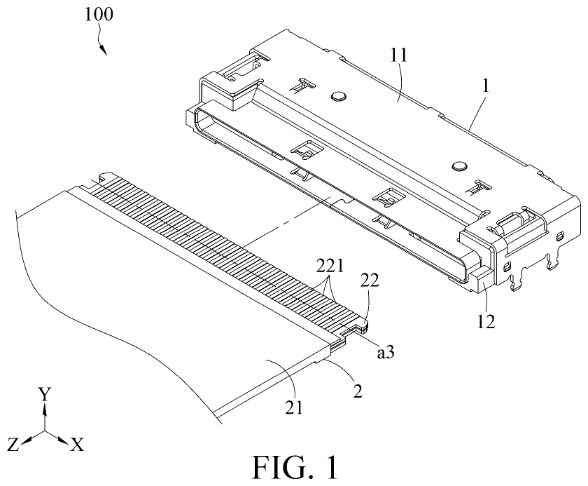

Please refer to FIG. 1. FIG. 1 illustrates a perspective view of a connector assembly 100, where the board-end connector 1 and the cable-end connector 2 of the connector assembly 100 are not mated with each other yet. The signal transmitted by the connector assembly 100 is identical to the signal transmitted by the MCIO connector, while the structure of the connector assembly 100 is different from the structure of the MCIO connector. The connector assembly 100 comprises a board-end connector 1 and a cable-end connector 2. The board-end connector 1 is an elongated connector. The long side of the board-end connector 1 extends along a first axis X direction, the short side of the board-end connector 1 extends along a third axis Z direction, and the height of the board-end connector extends along a second axis Y direction. The cable-end connector 2 is adapted to be applied for a flexible flat cable (FFC). Because the board-end connector 1 is adapted to be mated with the FFC type cable-end connector 2 which is lightweight and tiny, the size of the board-end connector 1 can be reduced relatively.

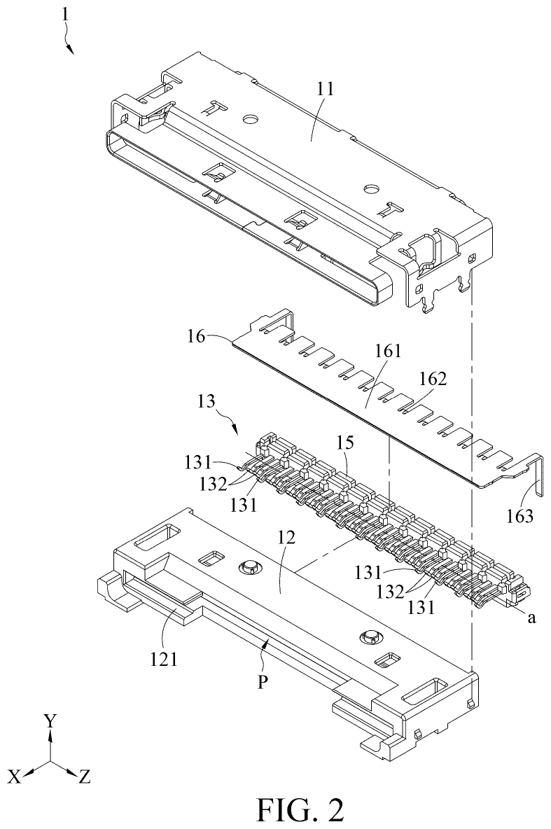

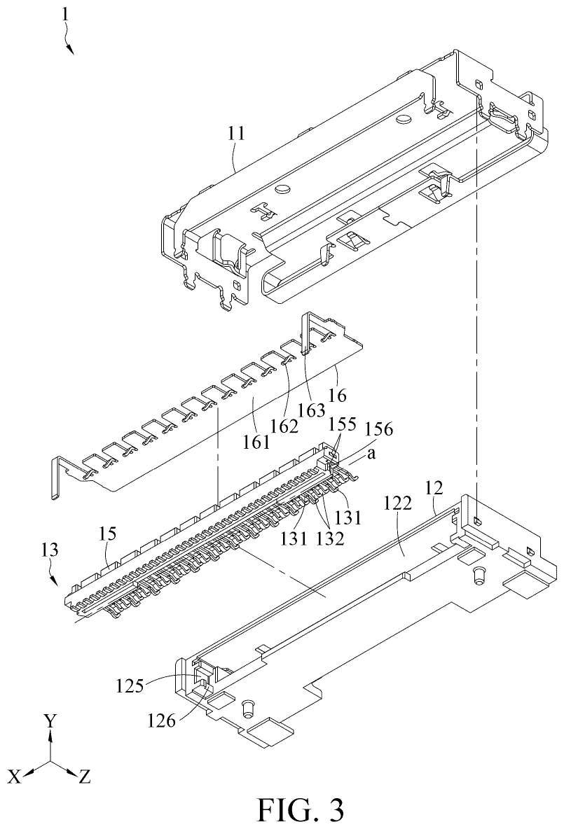

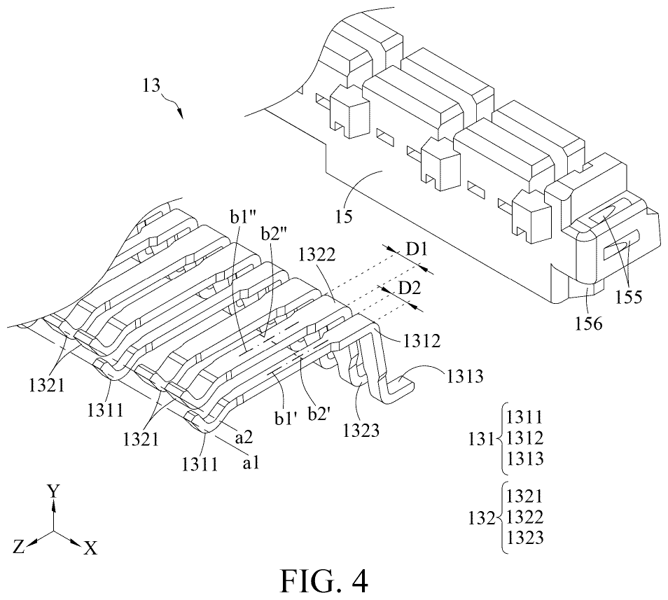

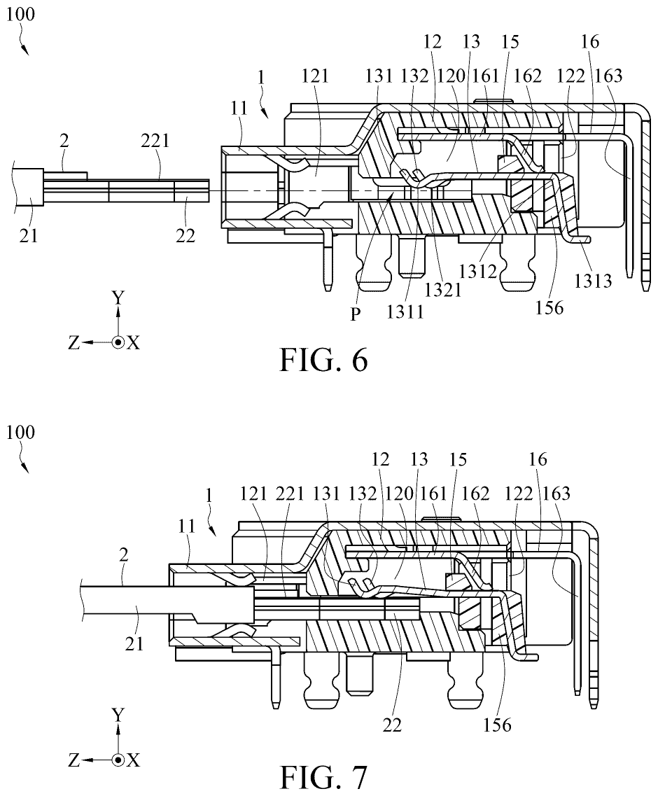

Please refer to FIG. 2 to FIG. 4. FIG. 2 illustrates a front exploded view of the board-end connector 1. FIG. 3 illustrates a rear exploded view of the board-end connector 1. FIG. 4 illustrates a partial exploded view of the terminal module 13 according to some embodiments of the instant disclosure. The board-end connector 1 comprises an outer shell 11, an insulated housing 12, and a terminal module 13. The insulated housing 12 is a hollow rectangular plastic core and in the outer shell 11 (as shown in FIG. 6). The insulated housing 12 has a receiving cavity 120, one of two ends of the insulated housing 12 has an insertion opening 121 in communication with the receiving cavity 120, and the other end of the insulated housing 12 has an assembling opening 122 in communication with the receiving cavity 120. The receiving cavity 120, the insertion opening 121, and the assembling opening 122 are together defined through the insulated housing 12 along the third axis Z direction, and the insertion opening 121 and the assembling opening are long and narrow openings extending along the first axis X direction. The insertion opening 121 and the assembling opening 122 are respectively at surfaces of the two end of the insulated housing 12.

The terminal module 13 is in the receiving cavity 120 of the insulated housing 12, and the terminal module 13 comprises a plurality of ground terminals 131 and a plurality of pairs of signal terminals 132. Each of the signal terminals 132 and the ground terminals 131 is a flexible terminal, each of the ground terminals 131 is a long terminal, each of the signal terminals 132 is a short signal, and the ground terminals 131 and the signal terminals 132 are arranged as a single row along an axial line a (which is identical to the first axis X). each of the ground terminals 131 comprises a first contact portion 1311, each of the signal terminals 132 comprises a second contact portion, and each of the first contact portion 131 and the second contact portion 132 is a curved structure protruding toward a bottom portion of the board-end connector 1 along the second axis Y direction.

The cable-end connector 2 comprises a flexible parallel cable 21 and a plug 22 at one end of the flexible parallel cable 21. One surface of the plug 22 comprises a plurality of contacts 221. In some embodiments, the flexible parallel cable 21 is a flexible flat cable (FFC), the length of the flexible parallel cable 21 is not limited, the plug 22 is an elongated plate, and two plugs 22 are at two ends of the flexible parallel cable 21, respectively. In some embodiments, each of the contacts 221 on the plug 22 is a flat terminal, a connection line between the contacts 221 defines a third axial line a3, and the direction of the third axial line is identical to the first axis direction. The contacts 221 are arranged along the third axial line a3 and spaced apart from each other, and the contacts 221 at the surface of the plug 22 are arranged into a single row. Lengths of the contacts 221 along the third axis Z direction are identical to each other, and widths of the contacts along the first axis X direction are identical to each other.

In some embodiments, a connection line of the first contact portions 1311 defines a first axial line a1, the direction of the first axial line a1 is identical to the direction of the first axis X direction, and the first contact portions 1311 are arranged along the first axial line a1 and spaced apart from each other; a connection line between the second contact portions 1321 defines a second axial line a2, and the second contact portions 1321 are arranged along the second axis line a2 and spaced apart from each other. The first axial line a1 and the second axial line a2 are parallel with each other.

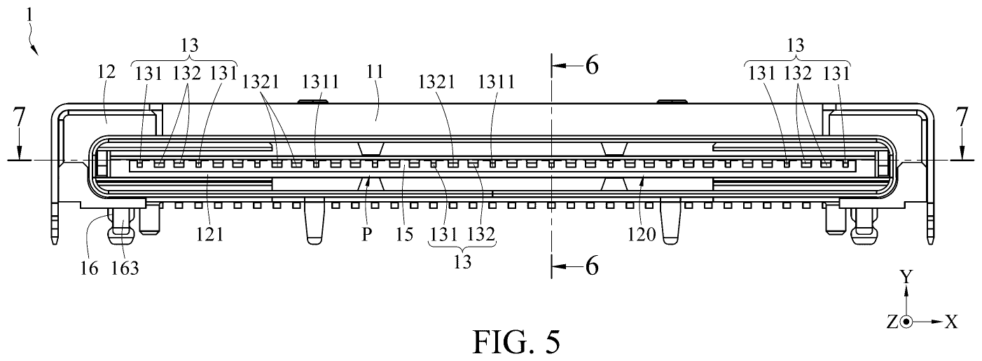

Please refer to FIG. 5. FIG. 5 illustrates a front view of the board-end connector 1 according to some embodiments of the instant disclosure. In some embodiments, upon viewing the insertion opening 121 of the insulated housing 12 along the third axis Z direction, the first contact portions 1311 and the second contact portions 1321 are in the receiving cavity 120 and are above the insertion opening 121, and the first contact portions 1311 and the second contact portions 1321 are arranged into a single row along the first axis X direction, but the instant disclosure is not limited thereto. In some embodiments, upon viewing the insertion opening 121 of the insulated housing 12 along the third axis Z direction, the first contact portions 1311 and the second contact portions 1321 are in the receiving cavity 120 and are below the insertion opening 121.

In some embodiments, the number of the ground terminals 131 and the signal terminals 132 is 37, the number of the signal terminals 132 is 24, and the number of the ground terminals 131 is 13. Each of the pairs of the signal terminals 132 are between corresponding two of the ground terminals 131. Upon viewing from FIG. 5 along the third axis Z direction, the arrangement of the terminals is, from left to right, the first terminal is a ground terminal 131, the second and third terminals are a first pair of signal terminals 132, the fourth terminal is a ground terminal 131, the fifth and sixth terminals are a second pair of signal terminals 132, the seventh terminal is a ground terminal 131, vice versa, the thirty-fourth terminal is a ground terminal 131, the thirty-fifth and thirty-sixth terminals are the twelfth pair of signal terminals 132, and the thirty-seventh terminal is a ground terminal 131.

Please refer to FIG. 4 to FIG. 6. FIG. 6 illustrates a cross-sectional view along line 6-6 shown in FIG. 5, where the board-end connector 1 and the cable-end connector 2 of the connector assembly 100 are not mated with each other yet. In some embodiments, each of the ground terminals 131 comprises a first body portion 1312 and a first tail portion 1313 adjacent to the assembling opening 122. For each of the ground terminals 131, the first contact portion 1311 extends outwards from one of two ends of the first body portion 1312 along the third axis Z direction, the first tail portion 1313 extends outwards from the other end of the first body portion 1312 along the third axis Z direction, and the first contact portion 1311 and the first tail portion 1313 are at two ends of the first body portion 1312, respectively. For each of the ground terminals 131, the first contact portion 1311 and the first body portion 1312 are substantially configured to be a mirrored L structure upon viewing from the first axis X direction, and the first body portion 1312 and the first tail portion 1313 are substantially configured to be an L structure upon viewing from the first axis X direction.

In some embodiments, each of the signal terminals 132 comprises a second body portion 1322 and a second tail portion 1323 adjacent to the assembling opening 122. For each of the signal terminals 132, the second contact portion 1321 extends outwards from one of two ends of the second body portion 1322 along the third axis Z direction, the second tail portion 1323 extends outwards from the other end of the second body portion 1322 along the third axis Z direction, and the second contact portion 1321 and the second tail portion 1323 are at two ends of the second body portion 1322, respectively. For each of the signal terminals 132, the second contact portion 1321 and the second body portion 1322 are substantially configured to be a mirrored L structure upon viewing from the first axis X direction, and the second body portion 1322 and the second tail portion 1323 are substantially configured to be an L structure upon viewing from the first axis X direction.

In some embodiments, each of the ground terminals 131 defines a longitudinal axis b1′ and a transverse axis b2′, the direction of the longitudinal axis b1′ of each of the ground terminals 131 is identical to the third axis Z direction, and the direction of the longitudinal axis b2′ of each of the ground terminals 131 is identical to the first axis X direction. Likewise, in some embodiments, each of the signal terminals 132 defines a longitudinal axis b1″ and a transverse axis b2″, the direction of the longitudinal axis b1″ of each of the signal terminals 132 is identical to the third axis Z direction, and the direction of the longitudinal axis b2″ of each of the signal terminals 132 is identical to the first axis X direction. For each of the ground terminals 131, the transverse axis b2′ is perpendicular to the longitudinal axis b1′. For each of the signal terminals 132, the transverse axis b2″ is perpendicular to the longitudinal axis b1″. The transverse axis b2′ of each of the ground terminals 131 and the transverse axis b2″ of the corresponding one of the signal terminals 132 are parallel with each other. A thickness of each of the signal terminals 132 is greater than a thickness of the corresponding one of the ground terminals 131, and a first width D1 of each of the signal terminals 132 along the transverse axis b2″ of the signal terminal 132 is greater than a second width D2 of a corresponding one of the ground terminals 131 along the transverse axis b2′ of the ground terminal 131. Accordingly, in some embodiments, through configuring the first width D1 of the signal terminal 132 to be greater than the second width D2 of the ground terminal 131, the demands for high frequency signal transmission can be achieved.

In some embodiments, the terminal module 13 comprises a terminal base 15. The terminal base 15 is a rectangular plastic core. The long side direction of the rectangular plastic core extends along the first axis X direction, and the short side direction of the rectangular plastic core extends along the third axis Z direction. The terminal base 15 is formed with the first body portions 1312 of the ground terminals 131 and the second body portions 1322 of the signal terminals 132 during the injection molding process. The first contact portions 1311 of the ground terminals 131 and the second contact portions 1321 of the signal terminals 132 are exposed from a front end surface of the terminal base 15, and the first tail portions 1313 of the ground terminals 131 and the second tail portions 1323 of the signal terminals are exposed from a bottom portion of the terminal base 15.

Please refer to FIG. 3, FIG. 4, and FIG. 6. In some embodiments, each of two sides of the terminal base 15 comprises a plurality of protrusions 155 and an engaging block 156, and the insulated housing 12 comprises a recessed portion 125 and an engaging groove 126 at each of two sides of an inner wall of the assembling opening 122. When the terminal base 15 is assembled in the assembling opening 122 along the third axis Z direction, each of the protrusions 155 of the terminal base 15 correspondingly contacts an inner wall of a corresponding one of the recessed portions 125, so that the two surfaces at the two sides of the terminal base 15 and the two side walls of the assembling opening 122 in the insulated housing 12 can be positioned with each other in an interference-fit manner, and the movements of the terminal base 15 along the first axis X direction, the second axis Y direction, and the third axis Z direction are limited. When a front inclined surfaces of the engaging block 156 of the terminal base 15 guides the engaging block 156 to be engaged with the engaging groove 126 of the insulated housing 12, a rear stopping surface of the engaging block 156 of the terminal base 15 is limited in the engaging groove 126, so that the terminal base 15 and the insulated housing 12 are combined with each other to limit the movement of the terminal base 15 along the third axis Z direction.

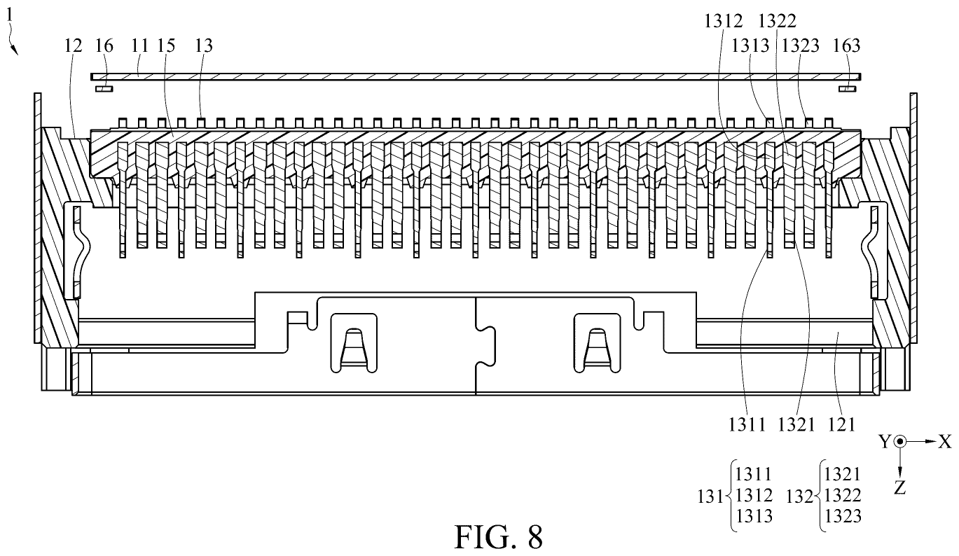

When the terminal module 13 is assembled in the receiving cavity 120 through the assembling opening 122 of the insulated housing 12, from the third axis Z direction, a distance between the first contact portion 1311 and the insertion opening 121 is shorter, while a distance between the second contact portion 1321 and the insertion opening 121 is longer. The first contact portions 1311 are adjacent to the insertion opening 121, and the second contact portions 1321 are away from the insertion opening 121. From the first axis X direction, the first contact portions 1311 and the second contact portions 1321 are respectively arranged in front of and behind the insertion opening 121 (as shown in FIG. 6 and FIG. 8).

Please refer to FIG. 4, FIG. 6, and FIG. 7. FIG. 7 illustrates a cross-sectional view along line 6-6 shown in FIG. 5, where the board-end connector 1 and the cable-end connector 2 of the connector assembly 100 are mated with each other. When the plug 22 of the cable-end connector 2 is inserted into the insertion opening 121 along the third axis Z direction, the plug 22 is inserted into the insertion opening 121 along an insertion path between the insertion opening 121 and the receiving cavity 120. Next, some of the contacts 221 on the surface of the plug 22 (the upper surface of the plug 22 shown in FIG. 1) firstly contact the first contact portions 1311 of the ground terminals 131, so that the first contact portions 1311 are pushed to swing toward a top portion of the receiving cavity 120 along the second axis Y direction. Then, when the plug 22 is further inserted into the receiving cavity 120 of the insulated housing 12 along the third axis Z direction, rest of the contacts 221 on the plug 22 contact the second contact portions 1321 of the signal terminals 132, so that the second contact portions 1321 are pushed to swing toward the top portion of the receiving cavity 120 along the second axis Y direction. Therefore, according to some embodiments, through the configuration that the contacts 221 firstly contact the first contact portions 1311 and then contact the second contact portions 1321, the terminal contact of the ground terminals 131 is achieved firstly for grounding and noise conduction and then the terminal contact of the signal terminals 132 is achieved for signal transmission.

Please refer to FIG. 2 and FIG. 7. In some embodiments, the connector assembly 100 further comprises a conductive body 16 for grounding and noise conduction. The conductive body 16 comprises a main body 161 and a plurality of extension portions 162. The main body 161 is a rectangular plate extending along the first axis X direction, each of the extension portions 162 is an inclined arm, and each of the extension portions 162 outwards extends from a rear portion of the main body 161. When the main body 161 is assembled in the receiving cavity 120 through the assembling opening 122, the main body 161 is in the receiving cavity 120 and on the terminal base 15, and each of the extension portions 162 is connected to the first body portion 1312 of a corresponding one of the ground terminals 131. The conductive body 16 further comprises a plurality of legs 163 outwards extending from two sides of the main body 161 along the same direction, and the legs 163 are adapted to be connected to a printed circuit board for grounding and noise conduction.

According to some embodiments of the instant disclosure, through the configuration that the first contact portions of the ground terminals are adjacent to the insertion opening of the insulated housing and the second contact portions of the signal terminals are away from the insertion opening, when the plug of the cable-end connector is inserted into the receiving cavity through the insertion opening of the insulated housing, some of the contacts on the plug of the cable-end connector firstly contact the first contact portions of the ground terminals, and then when the plug is further inserted into the receiving cavity, rest of the contacts contact the second contact portions of the signal terminals. Therefore, the terminal contact of the ground terminals is achieved firstly for grounding and noise conduction and then the terminal contact of the signal terminals is achieved for signal transmission.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A connector assembly, comprising:
a board-end connector comprising:
an outer shell;
an insulated housing in the outer shell, wherein the insulated housing has a receiving cavity, one of two ends of the insulated housing has an insertion opening in communication with the receiving cavity, and the other end of the insulated housing has an assembling opening in communication with the receiving cavity; and
a terminal module in the receiving cavity, wherein the terminal module comprises a plurality of ground terminals and a plurality of pairs of signal terminals arranged as a single row along an axial line, each of the pairs of the signal terminals are between corresponding two of the ground terminals, each of the ground terminals comprises a first contact portion adjacent to the insertion opening, and each of the signal terminals comprises a second contact portion away from the insertion opening; and
a cable-end connector comprising a flexible parallel cable and a plug at one end of the flexible parallel cable, wherein one surface of the plug comprises a plurality of contacts;
wherein when the plug of the cable-end connector is inserted into the receiving cavity through the insertion opening, each of the contacts firstly contacts the first contact portion of a corresponding one of the ground terminals and then contacts the second contact portion of a corresponding one of the signal terminals.

2. The connector assembly according to claim 1, wherein each of the ground terminals comprises a first body portion and a first tail portion adjacent to the assembling opening, and the first contact portion and the first tail portion are at two ends of the first body portion, respectively; each of the signal terminals comprises a second body portion and a second tail portion adjacent to the assembling opening, and the second contact portion and the second tail portion are at two ends of the second body portion, respectively.

3. The connector assembly according to claim 2, wherein each of the signal terminals defines a longitudinal axis and a transverse axis, and each of the ground terminals defines a longitudinal axis and a transverse axis; for each of the signal terminals, the transverse axis is perpendicular to the longitudinal axis, for each of the ground terminals, the transverse axis is perpendicular to the longitudinal axis, and a first width of each of the signal terminals along the transverse axis of the signal terminal is greater than a second width of a corresponding one of the ground terminals along the transverse axis of the ground terminal.

4. The connector assembly according to claim 2, wherein a connection line between the first contact portions defines a first axial line, and the first contact portions are arranged along the first axial line and spaced apart from each other; a connection line between the second contact portions defines a second axial line, and the second contact portions are arranged along the second axial line and spaced apart from each other; the axial line, the first axial line, and the second axial line are parallel with each other.

5. The connector assembly according to claim 2, wherein each of the signal terminals and the ground terminals is a flexible terminal, and each of the first contact portion and the second contact portion is a curved structure and at an insertion path between the insertion opening and the receiving cavity.

6. The connector assembly according to claim 2, wherein the terminal module comprises a terminal base formed with the first body portions of the ground terminals and the second body portions of the signal terminals, and the first tail portions of the ground terminals and the second tail portions of the signal terminals are exposed from the terminal base.

7. The connector assembly according to claim 6, wherein each of two sides of the terminal base comprises a plurality of protrusions and an engaging block, and the insulated housing comprises a recessed portion and an engaging groove at each of two sides of an inner wall of the assembling opening; each of the protrusions correspondingly contacts an inner wall of a corresponding one of the recessed portions, and each of the engaging blocks is correspondingly engaged with a corresponding one of the engaging grooves.

8. The connector assembly according to claim 6 further comprising a conductive body, wherein the conductive body comprises a main body and a plurality of extension portions, the main body is in the receiving cavity and on the terminal base, and the extension portions outwards extend from the main body and respectively connected to the first body portions.

9. The connector assembly according to claim 1, wherein the number of the signal terminals and the ground terminals is 37, the number of the signal terminals is 24, and the number of the ground terminals is 13.

10. The connector assembly according to claim 1, wherein the flexible parallel cable is a flexible flat cable, each of the contacts is a flat terminal, a connection line between the contacts is defined as a third axial line, the contacts are arranged along the third axial line and spaced apart from each other, and the contacts at the surface of the plug are arranged into a single row.
